(19) United States
(12) Patent Application Publication
(10) Pub. No.: US 2010/0280925 A1
(43) Pub. Date: Nov. 4, 2010

(54) QUALITY CLICK PRICING

(76) Inventors: J. Chad Wehrmaker, San Jose, CA (US); Jarrod Schwarz, San Francisco, CA (US); Umesh C. Lalchand, San Jose, CA (US); William Martin-Gill, (US)

Correspondence Address: SCHWEGMAN, LUNDBERG & WOESSNER/EBAY, P.O. BOX 2938, MINNEAPOLIS, MN, 55402, US

(21) Appl. No.: 12/434,519

(22) Filed: May 1, 2009

(51) Int. Cl. G06Q 10/00; G06Q 30/00; G06F 15/16

(52) U.S. Cl. 705/30; 705/400; 709/224

(57) ABSTRACT

A method and system for providing quality click pricing is presented. An example system comprises a click monitor configured to monitor clicks originated from a web site of an affiliate, a post click activity monitor to monitor post click indicators of those users that originated any of the monitored clicks, a click value generator, an earnings per click module, and a compensation calculator. The click value generator may be configured to determine a click value for the affiliate, based on post click indicators. The determined click value may be provided to the earnings per click module configured to translate a click value into a per click earnings value for an affiliate. The compensation calculator may be configured to determine compensation of the affiliate based on the click value and a number of clicks originated from the web site of the affiliate during a certain period of time.

### TECHNICAL FIELD

This application relates to the field of electronic Commerce (eCommerce) and, specifically to a computer-implemented quality click pricing method and system.

### BACKGROUND

An affiliate marketing program run by a company typically pays Internet publishers, Web masters, and online partners for driving business to the provider's web site. For example, when an affiliate program is run by an on-line trading platform provider, the provider may pay affiliates (that may include the provider's users) to drive new users and sales to the provider's web site. Affiliates may choose to promote a provider's company with banners, text links, and other tools. In return, they receive commissions for driving new active users, as well as any associated revenue. Some existing affiliate programs use a compensation scheme that is based on rewarding an affiliate based on certain actions performed by users that are considered to have been driven to a certain web site by the affiliate.

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a diagrammatic representation of a network environment within which an example quality click pricing system and method may be implemented;

FIG. 2 is block diagram of a system to provide quality click pricing, in accordance with one example embodiment;

FIG. 3 is an example architecture for determining a click value, in accordance with an example embodiment;

FIG. 4 is a flow chart of a method to provide quality click pricing, in accordance with an example embodiment; and

FIG. 5 is a diagrammatic representation of an example machine in the form of a computer system within which a set of instructions, for causing the machine to perform any one or more of the methodologies discussed herein, may be executed.

### DETAILED DESCRIPTION

Method and system are provided to facilitate an affiliate program that is designed to award affiliates (e.g., publishers and advertisers) based on the volume of traffic they drive to the target web-based provider and to permit per click compensation of an affiliate. For example, the amount of compensation awarded to an affiliate may be determined based on the calculated “quality” of the affiliate-generated clicks. The quality of the affiliate-generated clicks may be determined based on a model that takes into consideration factors, such as incremental revenue, the number of new active confirmed registered users, the value associated with the active confirmed registered user, as well as other factors that may indicate fraudulent activity on the part of the affiliate. The compensation may be therefore determined for each particular affiliate based on the quality of clicks (termed click value) generated by that affiliate.

In one example embodiment, the clicks originated from a web site of an affiliate are monitored and captured for a period of time. Any post click indicators associated with users that effectuated the monitored clicks are also monitored in order to determine the value of traffic generated by the affiliate and assign a per click value (or click value) to the traffic generated by that affiliate. Once a click value is determined, the affiliate is rewarded or compensated on the basis of the determined click value and the volume of traffic (expressed in clicks) driven by the affiliate to the provider's web site. The click value and the associated compensation may be periodically recalculated for each affiliate. A report including the recalculated compensation data may be provided to affiliates for review and reference.

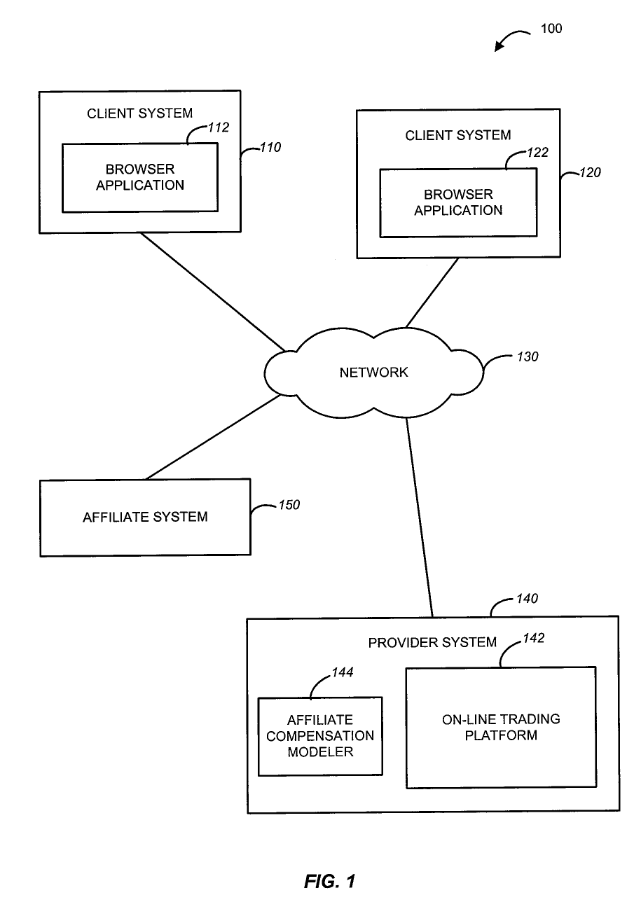

In some embodiments, a click value may be further processed according to predetermined rules to calculate per click compensation (or earnings) for an affiliate. For example, a certain percentage of the determined click value to be awarded to the affiliate may be set, as well as minimum and maximum thresholds for a per click earning may be established. An example method and system for providing quality click pricing may be implemented in the context of a network environment 100 illustrated in FIG. 1.

As shown in FIG. 1, the network environment 100 may include client systems 110 and 120 and a server system 140. The server system 140, in one example embodiment, may host an on-line trading platform 142. The client systems 110 and 120 may run respective browser applications 112 and 122 and may have access to the server system 140 via a communications network 130. The communications network 130 may be a public network (e.g., the Internet, a wireless network, etc.) or a private network (e.g., a local area network (LAN), a wide area network (WAN), Intranet, etc.).

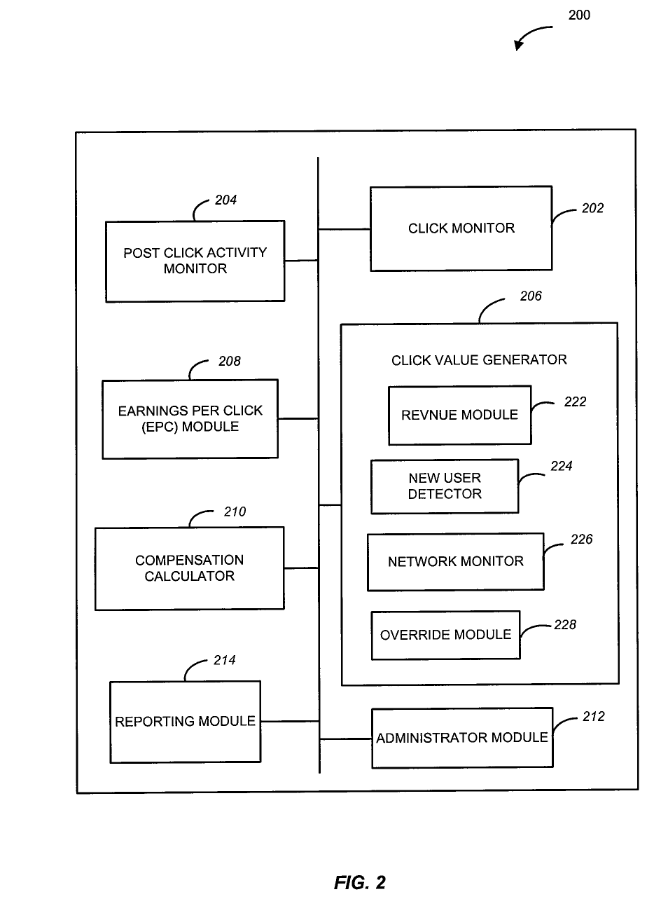

The client system 110 may utilize the browser application 112 to access services provided by the server system 140, such as, for example, to access web pages provided by the on-line trading platform 142 or web pages provided by a computer system of an affiliate (affiliate computer system 150). The server 140 may also host a system for providing quality click pricing (that may be termed an affiliate compensation modeler 144). While the affiliate compensation modeler 144 is illustrated as a stand-alone module, it may be implemented, e.g., as part of the on-line trading platform 142. An example affiliate compensation modeler may be described with reference to FIG. 2.

FIG. 2 is a block diagram of a system 200 for providing quality click pricing, in accordance with one example embodiment. The system 200, in one embodiment, corresponds to the affiliate compensation modeler 144 of FIG. 1. As shown in FIG. 2, the system 200 includes a click monitor 202, a post click activity monitor 204, a click value generator 206, an earnings per click module 208, and a compensation calculator 210. The click monitor 202 may be configured to monitor clicks originated from a web site of an affiliate. The post click activity monitor 204 may be configured to monitor post click indicators of those users that originated any clicks monitored by the click monitor 202. The click value generator 206 may be configured to determine a click value for the affiliate, based on post click indicators monitored by the post click activity monitor 204.

In one embodiment, where the system 200 is associated with an on-line trading platform, the monitored post click indicators may be associated with various activities of users, such as registering of a user with the on-line trading platform or placing bids on or purchasing items offered in the context of the on-line trading platform. In one example embodiment, the monitored post click indicators include revenue generated by a user who accessed the provider's web site as a result of any of the detected clicks or a registration confirmation associated with a new user. These indicators are processed to determine a perceived value (that can be a monetary value) of a click. The determined click value may be provided to the earnings per click module 208. The earnings per click module 208 may be configured to translate a click value into a per click earnings value for an affiliate. For example, the earnings per click value may be determined as a percentage of the click value. The system 200 may include an administrator module 212 that may permit the provider to configure rules for determining the earnings-per click value based on the click value.

The compensation calculator 210 may be configured to determine compensation of the affiliate based on the click value and a number of clicks originated from the web site of the affiliate requesting a web page of the provider during a certain period of time. For example, the compensation calculator 210 may be configured to determine compensation earned by the affiliate during a certain period of time by multiplying the number of clicks originated from the web site of the affiliate by the earnings per click value. The number of clicks originated from the web site of the affiliate and resulting in a request for a web page of the provider may be referred to as affiliate-generated traffic. The determined click value may be recalculated and updated periodically, in order to maintain an accurate assessment of the current value of affiliate-generated traffic. The affiliate's compensation is determined based on the current click value and the traffic generated by the affiliate during a period of time. The system 200 may also include a reporting module 214 to communicate to the affiliate a representation of a click value and/or compensation value accrued by the affiliate.

It will be noted, that while FIG. 2 shows particular modules as part of another component (e.g., a revenue module 222, a new user detector 224, a network monitor 226, and an override module 228 shown as part of the click value generator 206), other embodiments may be provided where some modules of the system 200 shown as separate components are implemented as a single module. Conversely, embodiments may be provided where a component that is shown in FIG. 2 as a single module may be implemented as two or more separate components.

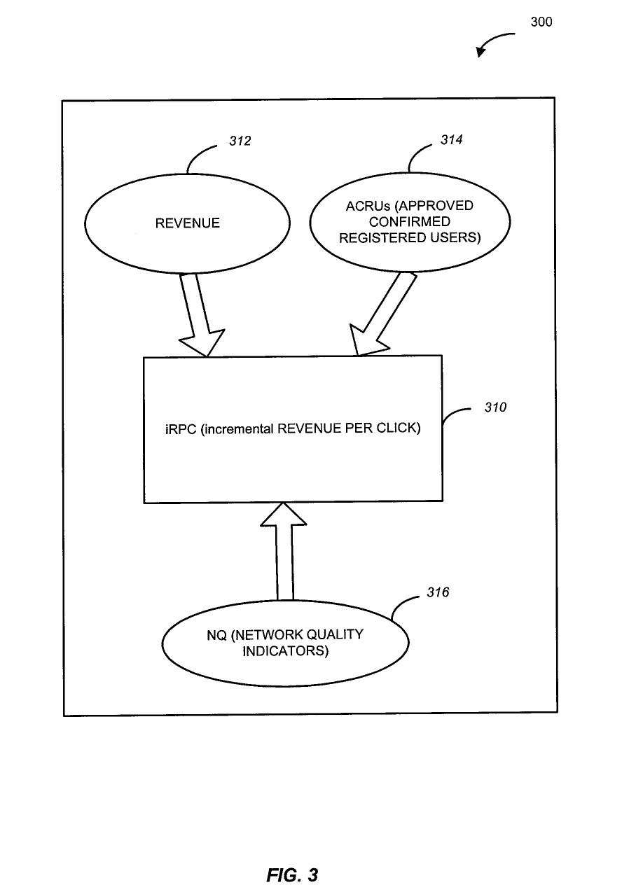

As mentioned above, the click value generator 206 may utilize various indicators, such as revenue resulting from affiliate-generated traffic, the number of new users directed to the provider's web site by the affiliate, and any irregularities with respect to the network traffic associated with the monitored clicks. The click value generator 206, in one example embodiment, comprises a revenue module 222 to determine revenue associated with clicks originated from the web site of the affiliate during the first period of time, a new user detector 224 to identify any new registered users associated with any of the clicks originated from the web site of the affiliate during the first period of time, and a network monitor 226 to detect any indication of irregularity in network activity associated with the clicks originated from the web site of the affiliate during the first period of time. In certain situations a provider may choose to determine the click value for a particular affiliate without any regard to the irregularities in the network activity. An override module 228 may be provided to determine that the indication of irregularity in network activity is to be disregarded based on a characteristic of a particular affiliate. An example architecture for determining a click value may be discussed with reference to FIG. 3.

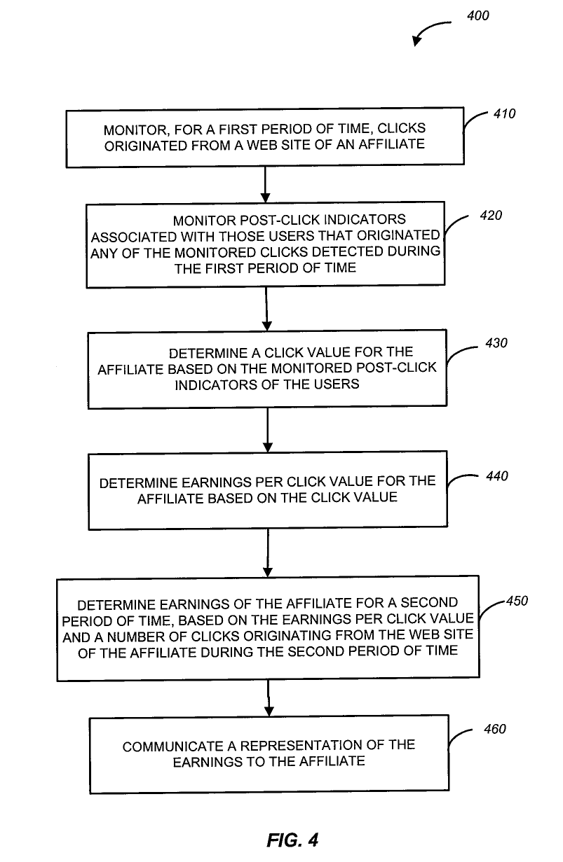

As shown in FIG. 3, in the architecture 300, a click value is referred to as incremental revenue per click (iRPC) identified in block 310. The input that may be used in determining iRPC includes, but is not limited to, revenue generated as a result of the affiliate-generated traffic to the provider's web site (identified as block 312), a value associated with approved confirmed registered users that registered for the provider's service as a result of the affiliate-generated traffic (identified as block 314), and network quality indicators identified as block 316. As mentioned above, a system for providing quality click pricing may be configured to disregard network quality indicators for certain affiliates. Various operations performed by a system for providing quality click pricing may be discussed with reference to FIG. 4.

FIG. 4 is a flow chart of a method 400 for providing quality click pricing, according to one example embodiment. The method 400 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the provider system 140 of FIG. 1 and, specifically, at the system for providing quality click pricing 200 shown in FIG. 2.

As shown in FIG. 4, the method 400 commences at operation 410, where the click monitor 202 of FIG. 2 monitors, for a first period of time, any clicks that originated from a web site provided by the affiliate computer system 150 of FIG. 1. At operation 420, the post click activity monitor 204 of FIG. 2 monitors post click indicators associated with those users that originated any of the monitored clicks. The click value generator 206 of FIG. 2 determines a click value (also referred to as an incremental revenue per click) for the affiliate, at operation 430. As mentioned above, a click value may be determined based on indicators associated with the monitored post click indicators of the users. At operation 440, the earnings per click module 208 of FIG. 2 determines earnings per click value of the affiliate. The earnings per click value reflects a portion of the click value (that may, in some cases, be equal to the click value itself) that is to be awarded to the affiliate for each click originated at the affiliate's web site that triggers a request for a web page of the provider. Thus, the click monitor 202, while monitoring clicks, may provide the compensation calculator 210 of FIG. 2 with a value reflecting the number of detected clicks originated at the affiliate's web site during a period of time, such that the compensation calculator 210 may calculate the earnings of the affiliate based on the earnings per click value for the affiliate and the number of clicks originated at the affiliate's web site that triggers a request for a web page of the provider detected over the period of time. The compensation of the affiliate accrued during the period of time is determined at operation 450. At operation 460, a presentation of the earnings is communicated to the affiliate, using the reporting module 214 of FIG. 2. The reporting module 214 may also be used to provide affiliates with a report indicating their respective earnings per click values.

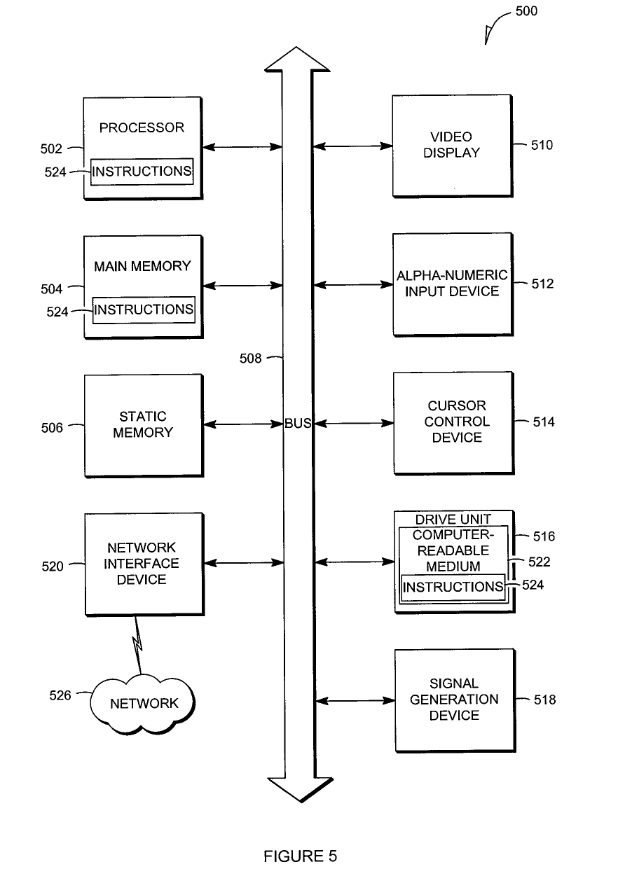

FIG. 5 shows a diagrammatic representation of a machine in the example form of a computer system 500 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processor 502 (e.g., a central processing unit (CPU), a graphics processing unit (GPU) or both), a main memory 504 and a static memory 506, which communicate with each other via a bus 508. The computer system 500 may further include a video display unit 510 (e.g., a liquid crystal display (LCD) or a cathode ray tube (CRT)). The computer system 500 also includes an alpha-numeric input device 512 (e.g., a keyboard), a user interface (UI) navigation device 514 (e.g., a cursor control device), a disk drive unit 516, a signal generation device 518 (e.g., a speaker) and a network interface device 520.

The disk drive unit 516 includes a machine-readable medium 522 on which is stored one or more sets of instructions and data structures (e.g., software 524) embodying or utilized by any one or more of the methodologies or functions described herein. The software 524 may also reside, completely or at least partially, within the main memory 504 and/or within the processor 502 during execution thereof by the computer system 500, with the main memory 504 and the processor 502 also constituting machine-readable media.

The software 524 may further be transmitted or received over a network 526 via the network interface device 520 utilizing any one of a number of well-known transfer protocols (e.g., Hyper Text Transfer Protocol (HTTP)).

While the machine-readable medium 522 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-state memories, optical and magnetic media. Such media may also include, without limitation, hard disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware.

Thus, a method and system for providing quality click pricing has been described. Although embodiments have been described with reference to specific example embodiments, it will be evident that various modifications and changes may be made to these embodiments without departing from the broader spirit and scope of the inventive subject matter. Accordingly, the specification and drawings are to be regarded in an illustrative rather than a restrictive sense. For example, while an embodiment has been described with reference to an on-line trading platform, a method and system for providing quality click pricing may be implemented and utilized advantageously in the context of various other on-line platforms.

What is claimed is:

1. A computer-implemented system comprising:
a click monitor to monitor clicks originated from a web site of an affiliate;
a post click monitor to monitor post click indicators associated with users that originated any clicks monitored by the click monitor;
a click value generator to determine a click value for the affiliate, based on the post click indicators monitored by a post click activity monitor, the post click indicators associated with the users that originated the clicks monitored by the click monitor over a first period of time; and
a compensation calculator to determine compensation of the affiliate accrued during a second period of time, the compensation of the affiliate reflecting the click value and a number of clicks originated from the web site of the affiliate detected by the click monitor during the second period of time.

2. The system of claim 1, comprising an earnings per click module to determine an earnings per click value based on the click value and one or more rules, wherein the compensation calculator is to determine the compensation of the affiliate during the second period of time by multiplying the number of clicks originated from the web site of the affiliate by the earnings per click value.

3. The system of claim 2, including an administrator module to configure the one or more rules for determining the earnings per click value based on the click value.

4. The system of claim 2, wherein a rule from the one or more rules indicates that the earnings per click value is a percentage of the click value.

5. The system of claim 1, wherein the click value generator comprises:
a revenue module to determine revenue associated with the clicks originated from the web site of the affiliate during the first period of time;
a new user detector to identify any new registered users associated with any of the clicks originated from the web site of the affiliate during the first period of time;
a network monitor to detect any indication of irregularity in network activity associated with the clicks originated from the web site of the affiliate during the first period of time,
wherein a click value detector is to utilize the determined revenue, any new registered users associated with any of the clicks originated from the web site of the affiliate during the first period of time, and any indication of irregularity in the network activity associated with the clicks originated from the web site of the affiliate during the first period of time to determine the click value for the affiliate.

6. The system of claim 4, wherein the click value generator includes an override module to determine that an indication of irregularity in network activity is to be disregarded, based on a characteristic of the affiliate.

7. The system of claim 1, wherein the click value generator is to:
monitor, for a third period of time, the clicks originated from the web site of the affiliate;
monitor post click activities of those users that originated any of the clicks monitored during the third period of time; and
update the click value based on the post click activities of those users that originated any of the clicks monitored during the third period of time.

8. The system of claim 1, wherein the monitored post click indicators are associated with an on-line trading platform.

9. The system of claim 1, comprising a reporting module to communicate a representation of the click value to the affiliate.

10. The system of claim 1, wherein the second period of time is subsequent to the first period of time.

11. A computer-implemented method comprising:
using one or more processors to perform operations of:
monitoring, for a first period of time, clicks originated from a web site of an affiliate;
monitoring post click indicators associated with those users that originated any of the monitored clicks;
determining a click value for the affiliate, based on the monitored post click indicators of the users; and
determining compensation of the affiliate accrued during a second period of time, the compensation of the affiliate reflecting the click value and a number of clicks originated from the web site of the affiliate during the second period of time.

12. The method of claim 11, comprising determining an earnings per click value based on the click value and one or more rules, wherein the compensation of the affiliate during the second period of time is calculated by multiplying the number of clicks originated from the web site of the affiliate by the earnings per click value.

13. The method of claim 12, wherein a rule from the one or more rules indicates that the earnings per click value is a percentage of the click value.

14. The method of claim 12, including configuring the one or more rules for determining the earnings-per click value based on the click value.

15. The method of claim 11, comprising communicating a representation of the click value to the affiliate.

16. The method of claim 11, wherein the determining of earnings comprises:
determining revenue associated with clicks originated from the web site of the affiliate during the first period of time;
identifying any new registered users associated with any of the clicks originated from the web site of the affiliate during the first period of time;
detecting an indication of irregularity in network activity associated with the clicks originated from the web site of the affiliate during the first period of time; and
utilizing the determined revenue, any new registered users associated with any of the clicks originated from the web site of the affiliate during the first period of time, and any irregularity in network activity associated with the clicks originated from the web site of the affiliate during the first period of time to determine the earnings.

17. The method of claim 16, including determining that the indication of irregularity in network activity is to be ignored, based on a characteristic of the affiliate.

18. The method of claim 11, including periodically updating the click value for the affiliate, based on:
monitoring, for a third period of time, clicks originated from the web site of the affiliate; and
monitoring post click activities of those users that originated any of the clicks monitored during the third period of time.

19. The method of claim 11, wherein the monitored post click indicators are associated with an on-line trading platform.

20. A machine-readable medium having instruction data to cause a machine to:
monitor clicks originated from a web site of an affiliate;
monitor post click indicators associated with those users that originated any clicks monitored by a click monitor;
determine a click value for the affiliate, based on the post click indicators, the post click indicators associated with the users that originated clicks monitored by the click monitor over a first period of time; and
determine compensation of the affiliate accrued during a second period of time, the compensation of the affiliate reflecting the click value and a number of clicks originated from the web site of the affiliate detected by the click monitor during the second period of time.
